(19) United States
(12) Patent Application Publication
(10) Pub. No.: US 2017/0008121 A1
(43) Pub. Date: Jan. 12, 2017

(54) ENHANCED FRICTION-STIR-WELDING JOINT STRENGTH BETWEEN STEEL AND ALUMINUM WITH SURFACE COATING AND PREFORMED LOCAL TEXTURE

(71) Applicant: GM Global Technology Operations LLC, Detroit, MI (US)

(72) Inventor: Huaxin Li, Rochester Hills, MI (US)

(21) Appl. No.: 14/791,584

(22) Filed: Jul. 6, 2015

(51) Int. Cl. B23K 20/12; B23K 20/24

(52) U.S. Cl. CPC B23K 20/1225; B23K 20/129; B23K 20/24

(57) ABSTRACT

A method and device for enhancing friction-stir-welding joint strength between aluminum and steel that has a surface coating by forming a local texture of points of raised elevation on the steel by stamping the steel, and then mechanically intermixing the steel and the aluminum with friction-stir-welding to form the joint.

### FIELD

This application relates generally to improvements in friction-stir-welding joint strength. More specifically, the application relates to methods and devices for enhancing friction-stir-welding joint strength between aluminum and steel that has a surface coating by forming a local texture of points of raised elevation and mechanically intermixing the steel and the aluminum to form the joint.

### BACKGROUND

Joining dissimilar metals is desirable for forming products with enhanced properties due to the combined aspects of each metal. However, due to great physical and metallurgical property differences between alloy systems, poor metallurgical bonding, high residual stresses, and poor joint strengths have limited such applications.

Combining alloys such as aluminum and magnesium with ferrous and nickel based alloys would be desirable for potentially creating products with enhanced and tailorable properties such as decreased and targeted weights. However, problems with weldability and poor joint strength have not been overcome.

There is a long felt need in the art for enhanced methods and devices for joining dissimilar metals. Provided herein are descriptions of such methods and devices, which enhance friction-stir welding joint strength between steel and aluminum with surface coating and preformed local texture.

### SUMMARY

Embodiments described herein provide for a method for enhancing friction-stir-welding joint strength between a steel plate and an aluminum plate, a preformed local texture, and with or without a surface coating on the steel plate. In specific embodiments an aluminum plate and a steel plate are provided. Methods can include coating a surface of the steel plate with a layer of at least one of zinc, aluminum, and silicon. The layer can be provided, for example, by hot-dipping the steel plate to form a surface coating. Such methods can include stamping at least a portion of the surface of the steel plate. Stamping the surface can be performed to form a preformed local texture of points of raised elevation in at least a portion of the steel plate. The raised elevation can range from about 0.010 millimeter to about 0.500 millimeter. Subsequently, friction-stir-welding can be performed to form the joint, with example methods including placing the steel plate in contact with the aluminum plate, and generating heat between a friction-stir-weld tool and the steel plate and the aluminum plate to form a softening of each of the metal plates near the friction-stir-weld tool. Methods can include applying, via the friction-stir-weld tool, mechanical pressure to the softened metals, and metallurgically and mechanically intermixing the steel plate and the aluminum plate to form the joint between the steel plate and/or the coating and the aluminum plate. In specific methods, the preformed local texture of the steel plate resides within the joint. In specific embodiments the speed of the friction-stir-weld tool tip is from about 1700 RPM to about 2000 RPM. In specific embodiments the speed is from about 1800 RPM to about 2000 RPM.

Additional embodiments described herein provide for a method for enhancing friction-stir-welding joint strength between a steel plate and an aluminum plate. In specific embodiments the steel plate has a surface coating at the start of the method, and in others the coating is added prior to any subsequent steps described herein. Methods can include providing an aluminum plate and a steel plate, and stamping at least a portion of a surface of the steel plate. The stamping can produce a preformed local texture formed of points of raised elevation in the surface of the steel plate. The friction-stir-welding can include placing the steel plate in contact with the aluminum plate and generating heat between the friction-stir-weld tool and the steel plate and the aluminum plate which leads to softening of each of the metal plates near the friction-stir-weld tool. Subsequently, the methods can include applying, via the friction-stir-weld tool, mechanical pressure to the softened metals, and metallurgically and mechanically intermixing the steel plate, steel surface coating, and the aluminum plate to form the joint between the steel plate and the aluminum plate. In specific methods the preformed local texture of the steel plate resides within the joint.

Yet additional embodiments described herein provide for a method for enhancing friction-stir-welding joint strength between a steel plate and an aluminum plate. The method can comprise providing an aluminum plate and a steel plate, coating a surface of at least one of the plates with a layer of zinc, aluminum, and silicon by hot-dipping the at least one of the plates to form the surface coating, and stamping at least a portion of the at least one of the plates comprising the surface coating to produce the preformed local texture formed of points of raised elevation in the at least the portion of the at least one of the plates. The method can also comprise friction-stir-welding to form the joint, wherein the friction-stir-welding comprises placing the steel plate in contact with the aluminum plate, and generating heat between a friction-stir-weld tool and the steel plate and the aluminum plate to form a softening of each of the metal plates near the friction-stir-weld tool. The method can also comprise applying, via the friction-stir-weld tool, mechanical pressure to the softened metals, and mechanically intermixing the steel plate and the aluminum plate and the surface coating to form the joint between the steel plate and the aluminum plate, the preformed local texture of the at least one of the plates residing therewithin.

### BRIEF DESCRIPTION OF THE FIGURES

FIG. 1A illustrates an enhanced friction-stir-welding joint between steel and aluminum with preformed local texture;

FIG. 1B illustrates an embodiment of a steel plate with a preformed local texture adjacent to an aluminum plate, and before a welding has been performed;

FIG. 2 illustrates another embodiment of a steel plate with a preformed local texture adjacent to an aluminum plate, and before a welding has been performed;

FIG. 3A illustrates a process for forming a coating on a steel plate;

FIG. 3B illustrates a cross-section of a steel plate showing a formed coating from a dipping process;

FIG. 3C illustrates a cross-section of a steel plate showing a formed coating substantially on a single side of the steel plate;

FIGS. 4A and 4B show the steel plate (4A) and a heating device (4B) for preparing the steel plate for a stamping;

FIG. 5A illustrates a female stamping tool above the steel plate which is held in a forming container;

FIG. 5B illustrates the steel plate of FIG. 5A after stamping by the female stamping tool;

FIG. 6A illustrates a male stamping tool above the steel plate;

FIG. 6B illustrates the steel plate of FIG. 6A after stamping by the male stamping tool;

FIG. 7A illustrates a friction-steel-tool above adjacent steel and aluminum plates, forming a lap joint;

FIG. 7B illustrates a continuous weld of the steel plate and the aluminum plate;

FIG. 8A illustrates a friction-steel-tool above adjacent steel and aluminum plates, and arrows indicating an example embodiment where spot welding can be performed;

FIG. 8B illustrates an embodiment of end to end joining of the steel plate and the aluminum plate, indicating preformed local texture can be formed on an end or ends of plates;

FIG. 9 illustrates an engine cradle produced according to method described herein;

The embodiments set forth in the drawings are illustrative in nature and are not intended to be limiting of the embodiments defined by the claims. Moreover, individual aspects of the drawings and the embodiments will be more fully apparent and understood in view of the detailed description that follows.

### DETAILED DESCRIPTION

Specific embodiments of the present disclosure will now be described. The invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which embodiments of this invention belong. The terminology used herein is for describing particular embodiments only and is not intended to be limiting of the invention. As used in the specification and appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about,” which is intended to mean up to ±10% of an indicated value. Additionally, the disclosure of any ranges in the specification and claims are to be understood as including the range itself and also anything subsumed therein, as well as endpoints. Unless otherwise indicated, the numerical properties set forth in the specification and claims are approximations that may vary depending on the desired properties sought to be obtained in embodiments of the present invention. Notwithstanding that numerical ranges and parameters setting forth the broad scope of embodiments of the invention are approximations, the numerical values set forth in the specific examples are reported as precisely as possible. Any numerical values, however, inherently contain certain errors necessarily resulting from error found in their respective measurements.

Parts of methods described herein such as mathematical determinations, calculations, inputting of data for computations or determinations of equations or parts thereof can be performed on parts of or one or more computers or computer systems that can include one or more processors, as well as software to run or execute programs and run calculations or computations.

Methods and systems and parts thereof described herein can be combined so as to implement embodiments of the invention. Forms of words used herein can have variations: for example when a word such as “form” is used, this implies that variations such as “formed” and “forming” are understood and have been considered.

As used herein, “plate” refers to a sheet of aluminum or steel. The sheet can be thin, and substantially: square, rectangular, triangular semi-circular, or circular piece of metal as viewed from a side, though it can also be formed in a shape necessary to comprise at least a portion of a vehicle chassis. The plate can be flat or formed from a flat piece into a shaped piece having angles. The plate can be formable and/or formed such that one or more pieces can be combined to form a curved portion of a chassis.

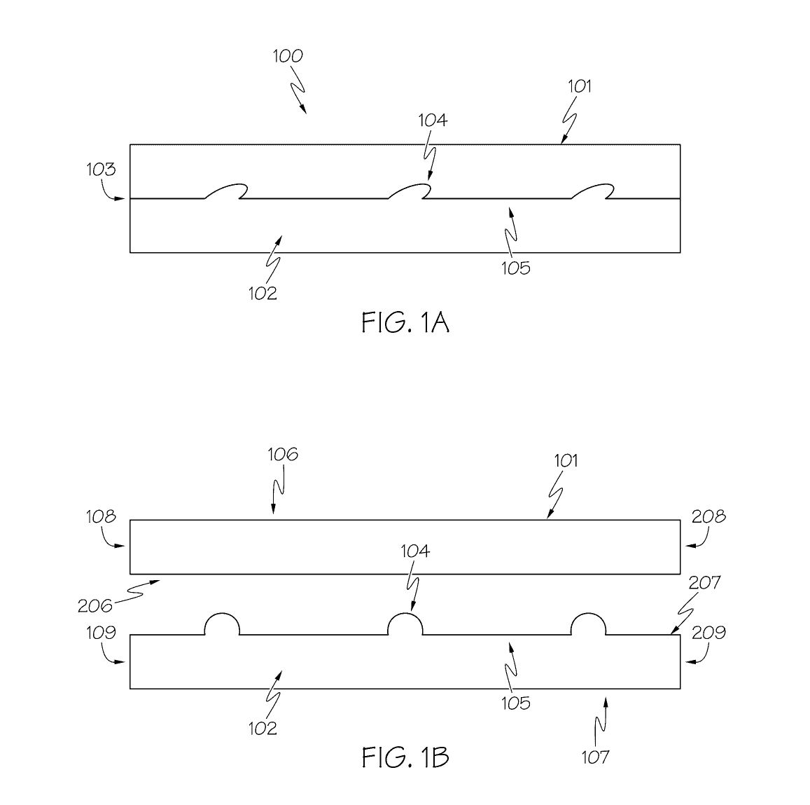

FIG. 1A illustrates an enhanced friction-stir-welding joint 103 between steel plate 102 and an aluminum plate 101 with preformed local texture comprising one or more points of raised elevation 104 and intervening smooth portions 105. By forming the one or more points of raised elevation 104, the surface area for joining is increased, and a stronger friction-stir-welding joint 103 can be formed. Such a joining enhances the metallurgical and mechanical bonding integrity and strength between the steel plate 102 and the aluminum plate 101 and minimizes the spring back and reduces residual stress at the joints. Additionally, it reduces friction-stir-welding tool wear due to the reduction in contact areas between the tool and the steel plate and the increase of energy concentration on the preformed texture surfaces.

A joined product 100 of aluminum plate 101 and the steel plate 102 can have one or more points of raised elevation 104 being at an angle to a longitudinal axis of the steel plate. In specific embodiments the angle between the one or more points of raised elevation 104 and the longitudinal axis of the steel plate 102 is ninety degrees, and in specific embodiments after the weld, the one or more points of raised elevation 104 have been bent into an angle of less than ninety degrees. In specific embodiments the angle of less than ninety degrees can be formed prior to the welding, and in other cases the welding causes the angling or deformation of the points of raised elevation 104.

FIG. 1B illustrates an embodiment of the steel plate 102 with a preformed local texture adjacent to an aluminum plate 101, and before a welding has been performed. The steel plate 102 has ends 109, 209, an outer side 107, and an inner side 207, the inner side referring to the side to be joined to the aluminum plate 101. Also illustrated on the inner side 207 of the steel plate 102 is the preformed local texture formed of one or more points of raised elevation 104 and smooth portions 105. The aluminum plate 101 has ends 108, 208, an outer side 106, and an inner side 206, the inner side 206 referring to the side to be joined to the steel plate 102.

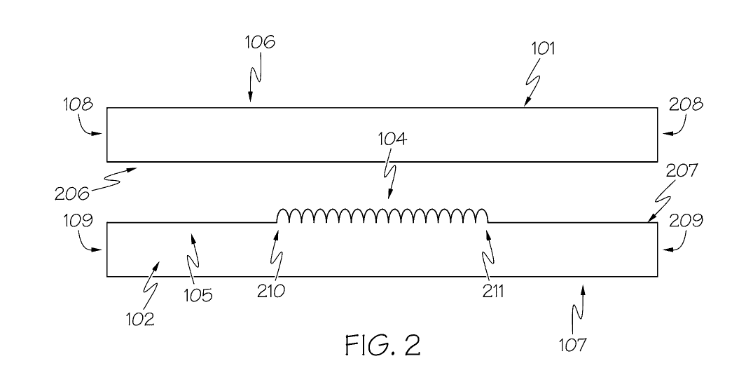

FIG. 2 illustrates another embodiment of a steel plate 102 with the preformed local texture adjacent to the aluminum plate 101, and before a welding has been performed. As with FIG. 1B, illustrated are the steel plate 102 having ends 109, 209, an outer side 107, and an inner side 207, the inner side referring to the side to be joined to the aluminum plate 101. Also illustrated on the inner side 207 of the steel plate is the preformed local texture formed of one or more points of raised elevation 104 and smooth portions 105. The aluminum plate 101 has an ends 108, 208, an outer side 106, and an inner side 206, the inner side referring to the side to be joined to the steel plate 102. In the embodiment, each of the points of raised elevation 104 are directly abutting another point of raised elevation 104, and points of raised elevation are located equidistant from opposing ends 109, 209 of the steel plate 102 and the smooth portions 105 extend out therefrom on either side to the edges 109, 209 of the steel plate 102. Methods described herein lead to points of reduced residual stresses 210, 211, due to a reduction of spring back due to the point of raised elevation 104.

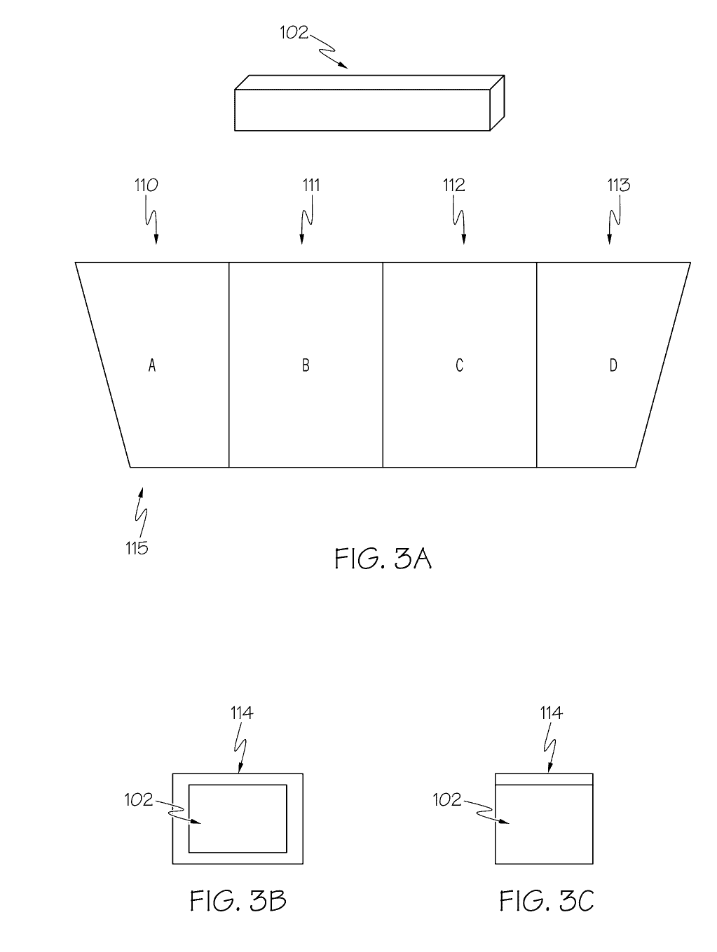

FIG. 3A illustrates a process for forming a coating 114 on the steel plate 102 such as hot-dip galvanization, the steps are which are illustrated at 115. Methods and devices of embodiments described herein can use one or more parts of the process. Specific embodiments have four dippings 110, 111, 112, 113, of the steel plate 102 into bins A, B, C, D, respectively. Bin A depicts a container of caustic soda to remove oils, paint, and markings, bin B depicts a container of an acid solution to remove rust or mill scale, bin C depicts a container of a flax solution to prevent oxidation, and bin D depicts a container of a solution of zinc. In specific embodiments, galvanized steel plates are directly used (the plates are provided as a first method step). In specific embodiments the aluminum plate 101 or parts thereof are coated in addition to the coating of the steel plate 102.

In specific embodiments there are rinse steps between one or more of the provided dippings. In specific embodiments the flux is zinc ammonium chloride is applied to the steel plate 102 to inhibit oxidation of the cleaned surface upon exposure to air; the flux is allowed to dry on the steel plate 102 and can aid in a process of the liquid zinc wetting and adhering to the steel. In specific embodiments the steel plate 102 is dipped into a molten zinc bath and held there until the temperature of the steel equilibrates with that of the bath.

FIG. 3B illustrates a cross-section of the steel plate 102 of FIG. 3A showing a formed coating 114 from a dipping process which can be seen on all four sides of the steel plate 102. In specific embodiments the coating 114 can be provided substantially or entirely on a single side of the steel plate 102 as shown in FIG. 3C which depicts the cross-section of another embodiments of the steel plate 102 from FIG. 3A. The steel plate 102 can be dipped just enough to create a surface coating 114 substantially on one side; alternatively the coating 114 could be applied by another method such as spraying.

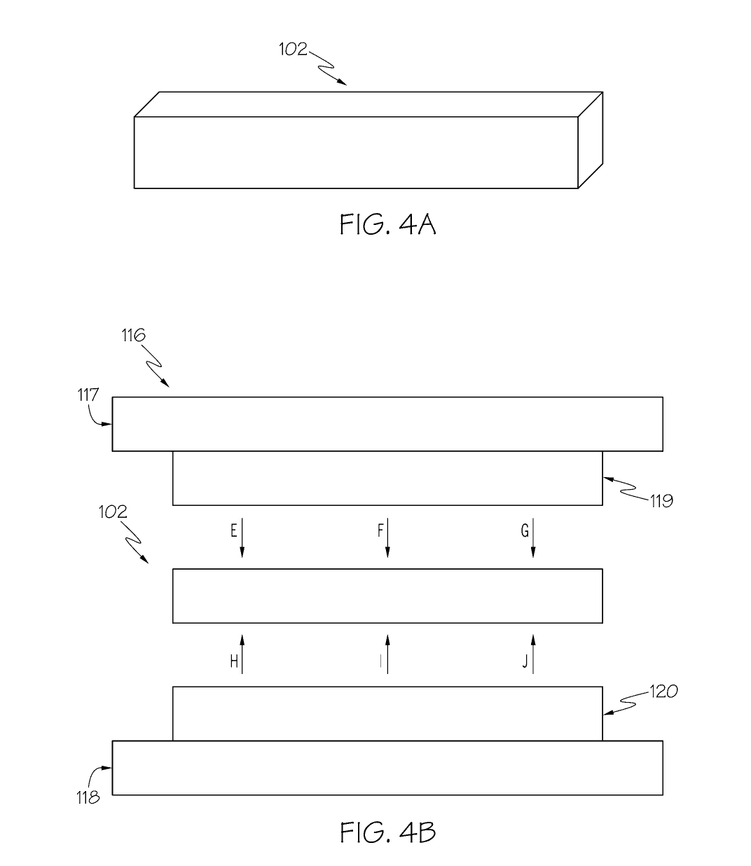

FIGS. 4A and 4B show the steel plate 102 (FIG. 4A) and a heating device 116 (FIG. 4B) for preparing the steel plate 102 for a stamping. FIG. 4B illustrates the heating device 116, having a top structural portion 117 and a bottom structural portion 118, each structural portion 117, 118 having a heating element 119, 120, respectively. The heating device 116 can accept the steel plate 102 between the heating elements 119, 120. Heat can be supplied to one side of the steel plate 102 via the heating element 119, as shown by arrows E, F, G and heat can be supplied to the other of the steel plate via the heating element 120, as shown by arrows H, I, J. In specific embodiments the steel plate can be placed in the heating device such that either side, or either end faces directly toward heating element 119 or heating element 120. In specific embodiments cold forming is used and heat is not applied to the plate/plates in producing the preformed local texture.

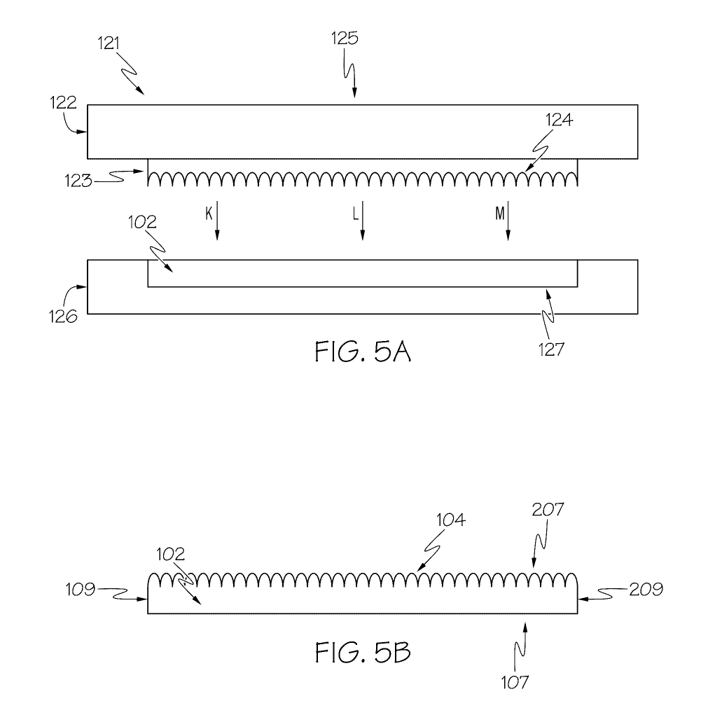

FIG. 5A illustrates a female stamping tool 121 above the steel plate 102 which is held in a forming container 126. The female stamping tool 121 has a top structural portion 122 coupled to a female die 123 having at least one recessed portion 124. The forming container 126 has a receiving area 127 for containing the steel plate 102. The top structural portion 122 can be pushed in direction 125 toward the receiving area 127 to stamp the steel plate 102 with the die 123. Arrows K, L, M illustrate direction of movement of the at least one recessed portion 124; the number can vary (for example, from about one to about ten, or about ten to about fifty, or about twenty-five to about fifty).

FIG. 5B illustrates the steel plate 102 of FIG. 5A after stamping by the female stamping tool 123. The steel plate 102, is shown to have the ends 109, 209, and the sides 107, 207. Though FIG. 5A illustrates the steel plate 102 having entirely smooth surfaces, FIG. 5B illustrates the points of raised elevation 104 formed by the female die 123. In specific embodiments the points of raised elevation 104 are tightly formed so as to form a line either longitudinally or laterally across the steel plate 102. In specific embodiments the points of raised elevation 104 are formed of a height of from about 0.010 millimeter to about 0.200 millimeter. In specific embodiments the points of raised elevation 104 are spaced from about 0.5 millimeter to about 1 millimeter.

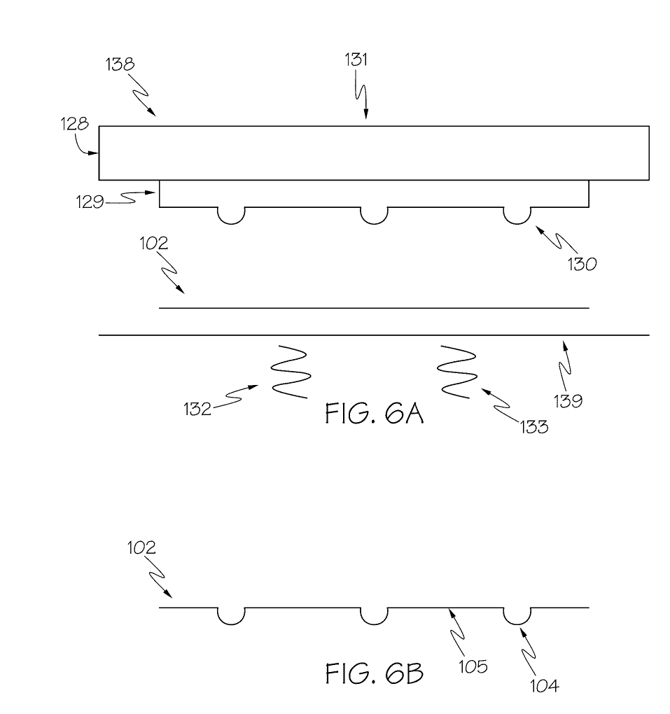

FIG. 6A illustrates a male stamping tool 138 above the steel plate 102. The male stamping tool 138 has a top structural portion 128 coupled to a male die 129 having at least one protruding portion 130. The top structural portion 128 can be pushed in direction 131 toward the steel plate 102. FIG. 6B shows the results of the stamping, showing the steel plate 102 and the smooth surface 105, as well as the points of raised elevation 104 formed by the male die 129. The points of raised elevation 104 point in the opposite direction of those shown in FIG. 5B, though the steel plate 102 can be turned over and used similarly as to the finished steel plate 102 shown in FIG. 5B regarding welding to the aluminum plate 101. For stamping with any of the dies provided herein, the steel plate can be placed on a conveyor belt 139, shown in FIG. 6A. The steel plate 102 can be placed on a conveyor belt 139 on springs 132, 133. As the belt moves laterally, a steel plate can be positioned below the male die, and a stamping can occur, forming the points of raised elevation 104 as the springs 132, 133 give to take some of the impact of the stamping while allowing the conveyor belt 139 to continue functioning. Upon stamping, the steel plate 102 can be moved, and the process can be repeated with new, unstamped steel plates. In another embodiment, the steel plate 102 is held in place for the stamping, and is not on a conveyor belt 139.

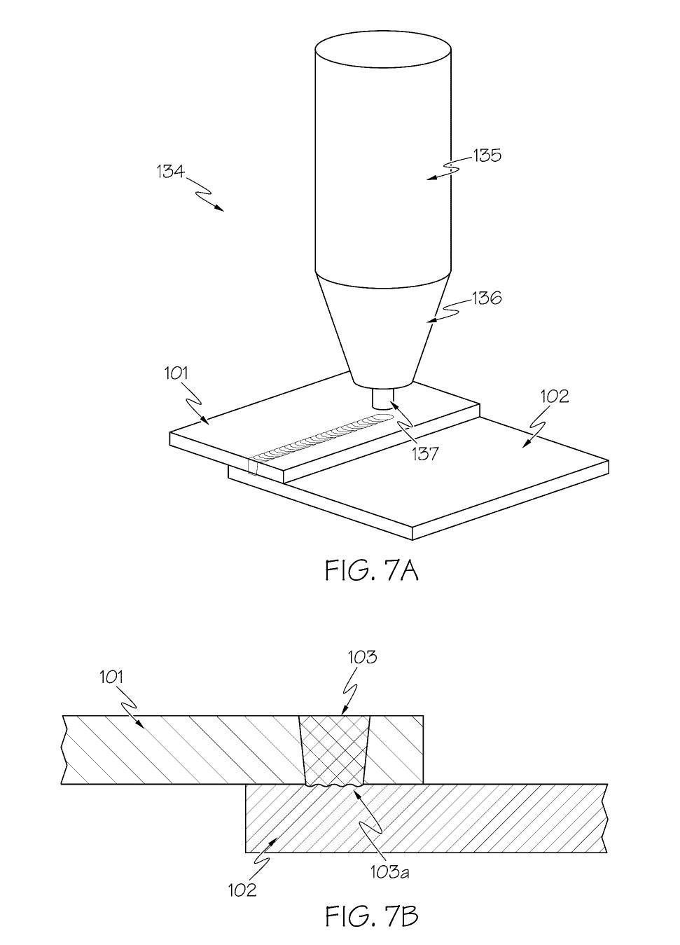

FIG. 7A illustrates a friction-steel-tool 134 above adjacent steel and aluminum plates (102, 101, respectively) forming a lap joint. The friction-steel-tool 134 is shown with a conical top portion 135, a middle portion 136 of smaller diameter than the conical top portion, and a tip 137. FIG. 7B illustrates the friction-stir-welding joint 103 between the steel plate 102 and the aluminum plate 101. In specific embodiments, as shown in FIG. 7B, the weld 103 is a continuous weld. Another example of friction-stir welding may be found in commonly owned U.S. Pat. No. 7,997,472 which is hereby incorporated by reference in its entirety. The weld-interface where the two plates are formed together is shown 103a, at which the aluminum plate 101, the steel plate 102, and any surface coating are intermixed upon welding; this is where the intermetallic compound of steel and aluminum (Fe₄Al₁₃) is formed, which in specific embodiments has a formed thickness that is substantially at or below the height of the points of raised elevation 104 (from about 0.010 millimeter to about 0.200 millimeter, or in specific embodiments from about 0.010 millimeter to about 0.10 millimeter). The thickness of the intermetallic compound would not be made substantially greater than the height of the points of raised elevation.

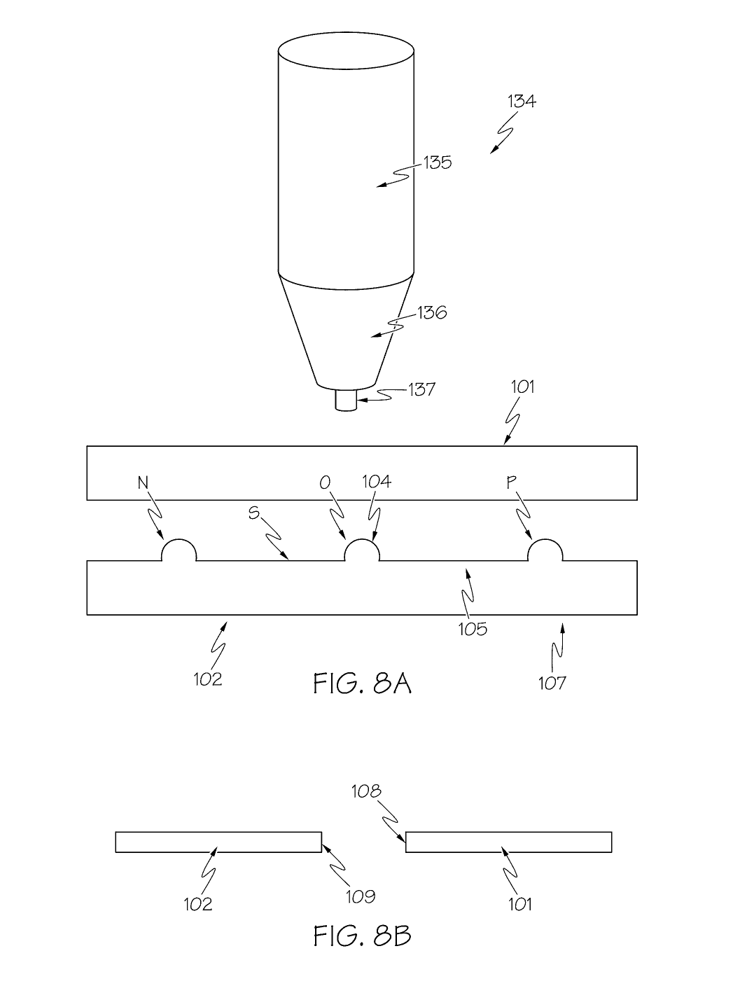

FIG. 8A illustrates the friction-steel-tool 134 above adjacent steel and aluminum plates (102, 101, respectively). The friction-steel-tool 134 is shown with the conical top portion 135, the middle portion 136 of smaller diameter than the conical top portion, and the tip 137. In specific embodiments the tip 137 radius is from about 20 millimeters to about 100 millimeters in diameter; in other embodiments the tip 137 is at least 20 millimeters in diameter. In yet other embodiments, a weld width of about 4 millimeters to about 10 millimeters is produced. The friction-steel-tool 134 can form spot welds at points N, O, P, to form three example spot welds corresponding to the points of raised elevation 104 and forming the friction-stir-welding joint 103 between the steel plate 102 and the aluminum plate 101. In specific embodiments spot welding is only performed at sites of points of raised elevation 104. In specific embodiments spot welding is also performed at smooth portions 105 as indicated at point S. For completeness the outer side 107 of the steel plate 102 is indicated. FIG. 8B illustrates an embodiment of end to end (109, 108) joining of the steel plate 102 and the aluminum plate 101, respectively, indicating preformed local texture can be formed on an end or ends (109, 209) of the steel plate.

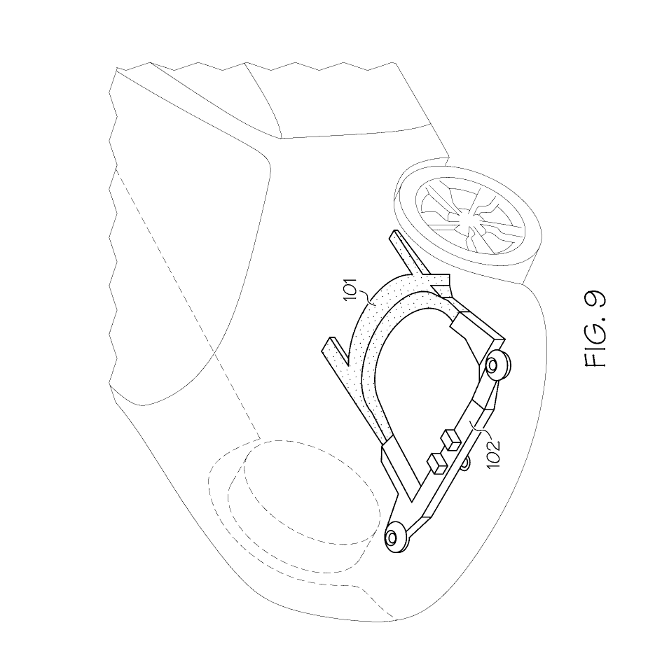

FIG. 9 illustrates an engine cradle according to the methods described herein. The cradle can be formed of at least one aluminum plate 101 and at least one steel plate 102. In specific embodiments the cradle has no bolts. In specific embodiments an aluminum steel-weld is formed as to the engine cradle, wherein there is at least one weld of about 30 to 40 millimeters in length and from about 2 to about 6 millimeters wide. In specific embodiments there are two welds in forming the cradle, one on each opposing side of the engine cradle and each from about 30 to 40 millimeters in length and from about 2 to about 6 millimeters wide. In other embodiments a part of a chassis is formed with the methods described herein.

In specific embodiments methods provided herein comprise producing, by stamping, the points of raised elevation 104 to a height of about one-hundred to about two-hundred microns from the at least the portion of the steel plate 102. In specific embodiments the height is from about 0.010 millimeters to about 0.200 millimeters. In specific embodiments the height is from about one-hundred-twenty five to about one-hundred seventy five microns.

Methods provided herein can comprise producing, by the stamping, the points of raised elevation 104 such that each of the points of raised elevation 104 comprise a dome shape. In specific embodiments one or more of the points of raised elevation 104 comprise a dome shape. In specific embodiments methods provided herein comprise producing, by stamping, the points of raised elevation 104 in a series of rows. In specific embodiments the surface coating 114 is provided over the entire surface of the steel plate 102, and mechanically intermixing the steel plate 102 and the aluminum plate 101 comprises forming the joint by applying the friction-stir-welding tool 134 to multiple coated surfaces of the steel plate 102.

Methods provided herein can further comprise placing the steel plate 102 in a forming container 126 prior to the stamping. This can be done so as to hold the shape of the steel plate 102, so that the shape of the steel plate 102 prior to the stamping and after the stamping is the same other than the formed points of raised elevation 104. In such an example, compression will increase the density of the steel plate 102 by changing the steel plate thickness in the direction of the stamping 125. In specific embodiments the steel plate can remain substantially flat other than the points of raised elevation 104.

As previously indicated, methods provided herein can comprise stamping with a female die 123. In specific embodiments methods provided herein further comprise stamping with a male die 129 such that raised points of elevation 104 extend out from the steel plate 102 in the direction away from the stamping. In specific embodiments methods provided herein further comprise stamping at least a second steel plate.

Methods provided herein can further comprise the surface coating 114 on the steel plate 102 comprising a layer of zinc, aluminum, and silicon. In specific embodiments the layer of zinc, aluminum, and silicon are applied via a dipping. In specific embodiments methods provided herein further comprise forming the friction-stir-welding joint 103 by spot welding.

Methods provided herein can further comprise forming the points of raised elevation 104 only in predetermined portions of the steel plate 102 which are separated from each other by substantially smooth portions 105. Methods can also comprise forming the friction-stir-welding joint 103 by spot welding only at each of the sites of the predetermined portions. In specific embodiments the predetermined portions can be provided by calculations on a computer which match to an automated welding system. In specific embodiments the points to be welded are determined in advance of the welding. Methods provided herein further comprise forming the friction-stir-welding joint 103 by substantially continuous welding, thus forming a single weld.

In specific embodiments methods provided herein further comprise forming the points of raised elevation 104 in the at least the portion of the surface of the steel plate 102 at an angle of from about ten to about seventy-five degrees from a longitudinal plane of the steel. In specific embodiments the angle can be from about thirty five degrees to about sixty five degrees or from about forty-five degrees to about fifty-five degrees from the longitudinal plane of the steel plate 102. The longitudinal plane of the steel plate 102 is, in specific embodiments, in the same direction as the friction-stir-welding joint 103 as shown in FIG. 1A

In specific embodiments methods provided herein further comprise a second stamping of the at least the portion of the surface of the steel plate 102 to form a second set of points of raised elevation 104 that are of a different height than those formed form the first stamping. For example one set could be from about one-hundred microns to about one-hundred fifty microns in height, and the other could be from about one-hundred fifty to about two hundred microns in height.

Having described embodiments of the invention in detail, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention. Methods and devices provided herein can also comprise determining the location and size (length and width of preformed local texture, forming the texture before or during or after the parts are formed, clamping the aluminum to the steel, locating weld locations ether manually or with pre-programmed robots, and friction stir welding the aluminum to the steel to form lap joints.

What is claimed is:

1. A method for enhancing friction-stir-welding joint strength between a steel plate and an aluminum plate comprising:
providing an aluminum plate and a steel plate;
coating a surface of the steel plate with a layer of zinc, aluminum, and silicon;
stamping at least a portion of the surface of the steel plate comprising the surface coating to produce the preformed local texture formed of points of raised elevation in the at least the portion of the steel plate; and
friction-stir-welding to form the joint, wherein the friction-stir-welding comprises:
placing the steel plate in contact with the aluminum plate;
generating heat between a friction-stir-weld tool and the steel plate and the aluminum plate to form a softening of each of the metal plates near the friction-stir-weld tool;
applying, via the friction-stir-weld tool, mechanical pressure to the softened metals; and
mechanically intermixing the steel plate and the aluminum plate to form the joint between them, the surface coating and the preformed local texture of the steel plate residing therewithin.

2. The method of claim 1, the stamping further comprising producing the points of raised elevation to a height of about one-hundred to about two-hundred microns.

3. The method of claim 2, the stamping further comprising producing the points of raised elevation such that each of the raised points comprises a dome shape.

4. The method of claim 3, the stamping further comprising producing the points of raised elevation in a series of rows.

5. The method of claim 1, further comprising providing the surface coating over the entire surface of the steel plate, and forming the joint by applying the friction-stir-welding tool to multiple coated surfaces of the steel plate.

6. The method of claim 1 further comprising placing the steel plate in a forming container prior to the stamping so as to hold the steel plate in a shape so that the shape of the plate prior to the stamping and after the stamping are the same other than the formed points of raised elevation and compression increasing the density of the steel plate thickness in the direction of the stamping, the at least the portion of the surface of the steel plate being substantially flat other than the points of raised elevation.

7. The method of claim 6 further comprising stamping with a female die.

8. The method of claim 1 further comprising forming the points of raised at an angle of from about ten to about seventy-five degrees from a longitudinal plane of the steel.

9. The method of claim 1, further comprising providing the stamping with a male die such that raised points of elevation extend out from the steel plate in the direction away from the stamping.

10. The method of claim 1 further comprising stamping at least a second steel plate.

11. The method of claim 8, further comprising forming, with the steel plates, at least a part of an engine cradle.

12. A method for enhancing friction-stir-welding joint strength between a steel plate and an aluminum plate comprising:
providing an aluminum plate and a steel plate;
stamping at least a portion of a surface of the steel plate comprising a surface coating to produce a preformed local texture formed of points of raised elevation in the at least the portion of the steel plate; and
friction-stir-welding to form the joint, wherein the friction-stir-welding comprises:
placing the steel plate in contact with the aluminum plate;
generating heat between a friction-stir-weld tool and the steel plate and the aluminum plate which leads to softening of each of the metal plates near the friction-stir-weld tool;
applying, via the friction-stir-weld tool, mechanical pressure to the softened metals; and
mechanically intermixing the steel plate and the aluminum plate and the surface coating to form the joint between the steel plate and the aluminum plate, the preformed local texture of the steel plate residing therewithin.

13. The method of claim 12 wherein the surface coating on the steel plate comprises a layer of zinc, aluminum, and silicon.

14. The method of claim 13 further comprising forming the joint by spot welding.

15. The method of claim 13 further comprising forming the points of raised elevation only in predetermined portions of the steel plate which are separated from each other by substantially smooth portions of the steel plate, and the joint is formed from spot welding only at each of the sites of the predetermined portions.

16. The method of claim 12 further comprising stamping at least a second steel plate.

17. The method of claim 16, further comprising forming, with the steel plates, at least a part of a vehicle chassis.

18. The method of claim 12 further comprising forming the points of raised elevation in the at least the portion of the surface of the steel plate at an angle of from about twenty-five to about seventy-five degrees from a longitudinal plane of the steel.

19. The method of claim 12 further comprising a second stamping of the at least the portion of the surface of the steel plate to form a second set of points of raised elevation that are of a different height than those formed form the first stamping.

20. A method for enhancing friction-stir-welding joint strength between a steel plate and an aluminum plate comprising:
providing an aluminum plate and a steel plate;
coating a surface of at least one of the plates with a layer of zinc, aluminum, and silicon;
stamping at least a portion of the plate that defines the surface coating thereon to produce the preformed local texture formed of points of raised elevation; and
friction-stir-welding to form the joint, wherein the friction-stir-welding comprises:
placing the steel plate in contact with the aluminum plate;
generating heat between a friction-stir-weld tool and the steel plate and the aluminum plate to form a softening of each of the metal plates near the friction-stir-weld tool;
applying, via the friction-stir-weld tool, mechanical pressure to the softened metals; and
mechanically intermixing the steel plate and the aluminum plate and the surface coating to form the joint between the steel plate and the aluminum plate, the preformed local texture of the at least one of the plates residing therewithin.
